(19) United States
(12) Patent Application Publication
(10) Pub. No.: US 2025/0085142 A1
(43) Pub. Date: Mar. 13, 2025

(54) AUTOMATIC CALIBRATION OF ENCODERS BASED ON TEMPERATURE

(71) Applicant: Avago Technologies International Sales Pte. Limited, Singapore (SG)

(72) Inventors: Wei Keat Yew, Pulau Pinang (MY); Thomas Theil, Feldafing (DE); Childs Chang, Penang (MY); Heem Leong Ong, Penang (MY); Kheng Hin Toh, Penang (MY)

(21) Appl. No.: 18/466,817

(22) Filed: Sep. 13, 2023

(51) Int. Cl. G01D 18/00

(52) U.S. Cl. CPC G01D 18/001

(57) ABSTRACT

Novel tools and techniques are provided for implementing an encoder capable of performing a self-calibration or self-correction process, and more particularly methods, systems, and apparatuses are provided for implementing an encoder capable of performing a process to calibrate itself or correct a signal of a sensor at different detected temperatures of an environment. In various embodiments, the encoder includes an exciter and a sensor capable of detecting a position of the exciter and generating a signal based on the position of the exciter. The encoder can then perform one or more steps to calibrate itself or self-correct a signal at different temperatures and calculate one or more values to correct a signal generated by the sensor.

### CROSS-REFERENCES TO RELATED APPLICATIONS

The present application is related to U.S. application Ser. No. 18/466,801 (attorney docket number 1317.230053US01), entitled “Automatic Calibration of Encoders”, filed Sep. 13, 2023, and to U.S. application Ser. No. 18/466,811 (attorney docket number 1317.230050US01), entitled “Automatic Stabilization of Encoders”, filed Sep. 13, 2023, which are commonly owned and incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing an encoder calibration or correction, and more particularly to methods, systems, and apparatuses for implementing an automatic encoder calibration or correction for different temperatures.

### BACKGROUND

Most types of encoders need to be calibrated before the encoders are used. The calibration of an encoder is typically only performed once in an encoder's lifetime (e.g., upon first setup of the encoder). However, the accuracy or effectiveness of an encoder's calibration can further depend on temperature. For example, an accuracy of detection of a signal can vary when the encoder is subjected to different temperatures. This means that a first process to calibrate an encoder and correct a signal of a sensor of the encoder at a first temperature may not be accurate to correct a signal of the sensor at a second temperature.

Hence, there is a need for more robust and scalable solutions for implementing encoder calibration. Thus, methods, systems, and apparatuses for implementing encoder calibration at different detected temperatures are provided.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is perspective view of a system having an encoder, in accordance with various embodiments:

FIG. 2A is a perspective view of an exciter of a magnetic encoder, in accordance with various embodiments;

FIG. 2B is a top view of an exciter of an optical encoder, in accordance with various embodiments;

FIG. 3 is a flow diagram of a method of calibrating an encoder or correcting a signal of the encoder, in accordance with various embodiments; and

FIG. 4 is a flow diagram of a method of correcting a signal of the encoder, in accordance with various embodiments.

### DETAILED DESCRIPTION OF EMBODIMENTS

Various embodiments provide tools and techniques for implementing an encoder capable of calibrating itself. More particularly, methods, systems, and apparatuses are provided for implementing encoder calibration based on a detected temperature.

In a first aspect, an encoder includes an exciter, a first sensor configured to detect a first temperature of an environment, a second sensor configured to detect a position associated with the exciter and generate a signal based on the position associated with the exciter, and a controller. The controller is further configured to detect the first temperature of the environment using the first sensor; determine a first process to correct the signal has not been run for the first temperature; based on a determination that the first process has not been run for the first temperature, running the first process to correct the signal based on the first temperature; and based on the first process and the first temperature, calculate a first value to correct the signal received from the second sensor.

In some cases, the first value to correct the signal of the encoder comprises at least one of a first correction value to correct an offset of the signal, a second correction value to correct a gain of the signal, or a third correction value to correct a phase of the signal. The first process to correct the signal of the encoder can occur (e.g., in real time) as the encoder is operating.

In some embodiments, after calculating the first value, the controller is further configured to add the first value to a look-up table for the encoder and associate the first value with the first temperature detected. The controller is further configured to use the look-up table to correct the first signal received from the sensor based on a detection of a second temperature of the environment. In some cases, using the look up table includes looking up the second temperature of the environment in the look up table to determine a second value to correct the signal received from the sensor; and using the second value from the look up table to correct the signal based on the second temperature.

In some instances, in response to a first determination that a second value to correct the signal is not stored in the look-up table for the second temperature and in response to a second determination that a second process to correct the signal cannot be run for the second temperature, the controller is further configured to calculate the second value associated with the second temperature, wherein the second value is calculated using a third value to correct the signal associated with a third temperature for which a corresponding process to correct the signal of the encoder has been run. In some cases, the second value is calculated using a linear formula using the third value associated with the third temperature.

In various instances, determining whether the first process has been run for the first temperature detected, further comprises determining whether the first temperature detected is within a predetermined range of temperatures that have not been corrected and, based on a determination that the first process has not been run for the predetermined range of temperatures, running the first process based on the first temperature detected.

In some instances, the controller is further configured to, after calculating the first value, add the first value to a look-up table for the encoder and associate the first value with the first temperature detected. The controller can further be configured to determine an additional value for an other temperature within the predetermined range based on the first value associated with the first temperature detected. In some cases, the additional value is determined using at least one of a linear formula or a polynomial formula. In various cases, the look-up table is stored on a memory of the encoder.

In various embodiments, the controller is further configured to determine whether the encoder is being used; and based on a determination that the encoder is being used, delay or stop the first process to correct the signal of the encoder.

In another aspect, a method for correcting a signal of an encoder can include detecting a first temperature of an environment using a first sensor of the encoder; determining a first process to correct the signal has not been run for the first temperature detected; based on a determination that the first process to correct the signal has not been run for the first temperature detected, running the first process based on the first temperature detected; and based on the first process, calculating a first value to correct a signal received from a second sensor of the encoder.

In some cases, the first value to correct the signal of the encoder comprises at least one of a first correction value to correct an offset of the signal, a second correction value to correct a gain of the signal, or a third correction value to correct a phase of the signal. The first process to correct the signal of the encoder can occur (e.g., in real time) as the encoder is operating.

In some embodiments, after calculating the first value, the method further includes adding the first value to a look-up table for the encoder and associating the first value with the first temperature detected. The method further includes using the look-up table to correct the first signal received from the sensor based on a detection of a second temperature of the environment. In some cases, using the look up table includes looking up the second temperature of the environment in the look up table to determine a second value to correct the signal received from the sensor; and using the second value from the look up table to correct the signal based on the second temperature.

In some instances, in response to a first determination that a second value to correct the signal is not stored in the look-up table for the second temperature and in response to a second determination that a second process to correct the signal cannot be run for the second temperature, the method further includes calculating the second value associated with the second temperature, wherein the second value is calculated using a third value to correct the signal associated with a third temperature for which a corresponding process to correct the signal of the encoder has been run. In some cases, the second value is calculated using a linear formula using the third value associated with the third temperature.

In various instances, determining whether the first process has been run for the first temperature detected, further comprises determining whether the first temperature detected is within a predetermined range of temperatures that have not been corrected and, based on a determination that the first process has not been run for the predetermined range of temperatures, running the first process based on the first temperature detected.

In some instances, the method further comprises, after calculating the first value, adding the first value to a look-up table for the encoder and associate the first value with the first temperature detected. The method can further include determining an additional value for an other temperature within the predetermined range based on the first value associated with the first temperature detected. In some cases, the additional value is determined using at least one of a linear formula or a polynomial formula. In various cases, the look-up table is stored on a memory of the encoder.

In yet another aspect, an encoder includes an exciter; a first sensor configured to detect a first temperature of an environment; a second sensor configured to detect a position associated with the exciter and generate a signal based on the position; and a processor. The processor is configured to detect the temperature of the environment using the first sensor; determine the signal of the encoder has not been corrected for the temperature detected; and based on a determination that signal has not been corrected for the temperature detected, correct the signal for the temperature detected.

In the following description, for the purposes of explanation, numerous details are set forth to provide a thorough understanding of the described embodiments. It will be apparent to one skilled in the art, however, that other embodiments may be practiced without some of these details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Similarly, when an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Furthermore, the methods and processes described herein may be described in a particular order for ease of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Additionally, it should be understood that spatial descriptions (e.g., “above,” “below,” “up,” “left,” “right,” “down,” “top,” “bottom,” “middle,” “vertical,” “horizontal,” etc.) used herein are for purposes of illustration only, and that practical implementations of the structures described herein can be spatially arranged in any orientation or manner.

In various existing encoder calibration processes, an encoder is only calibrated once upon initial setup. However, the angular position and rotation speed of an encoder can vary at different temperatures from the temperature at initial setup. Performing a calibration for different temperatures is not feasible due to time constraints and the amount of resources needed to subject the encoder to different temperature conditions. Thus, the calibration of the encoder at the initial setup of the encoder can be inaccurate for the range of temperatures the encoder actually experiences.

The proposed encoder can rerun the calibration cycle for different temperatures detected. For example, each time a new temperature or a new temperature within a predetermined range is detected, a calibration cycle can be run to correct a signal generated by a sensor of the encoder. In this way, the encoder can access accurate values to correct the signal of the sensor based on a temperature detected by the encoder. The process to self-calibrate the encoder or self-correct a signal of the encoder can be similar to the process described in application Ser. No. 18/466,801, “Automatic Calibration of Encoders” or application Ser. No. 18/466,811, “Automatic Stabilization of Encoders” which are herein incorporated by reference in their entirety.

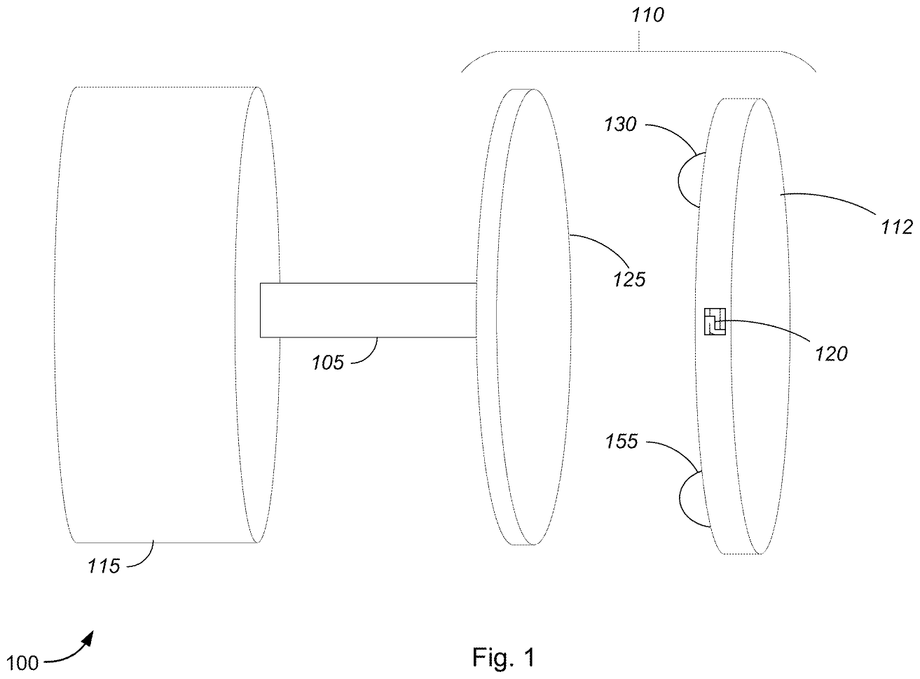

FIG. 1 is a perspective view of system 100 including a rotating body 105 and an encoder 110, in accordance with various embodiments. The rotating body 105 includes, without limitation, a rotor disc, a shaft, and/or the like. In some cases, the rotating body 105 might be coupled to an optional motor 115 (e.g., electric motor, or the like). The motor 115 may be configured to cause the rotating body 105 to rotate.

In some embodiments, the encoder 110 includes a processor or controller 120, an exciter 125, a first sensor 130, and a temperature sensor 155. In various instances, the encoder 110 further includes a memory (not shown) which could be a non-transitory memory. In various embodiments, the controller 120 may be implemented in a system-on-chip (SoC) arrangement. The controller 120 might include a Microcontroller Unit (MCU), an Application Specific Integrated Chip (ASIC), or other forms of silicon based embedded chips.

The encoder 110 can be a magnetic encoder, an optical encoder, or the like. The term “magnetic encoder” refers to a type of rotary encoder that uses one or more sensors to identify changes in magnetic fields from a rotating device (e.g., a magnetized wheel or ring, or the like) and generates signals indicating the angular position of the rotating device. The term “optical encoder” refers to a type of rotary encoder that uses one or more sensors to identify changes in light associated with the rotating device (e.g., a code wheel, code disc, or the like) and generates signals indicating an angular position of the rotating device. In some embodiments, the encoder 110 is an absolute encoder which comprises a sensor that measures an absolute or true angular position of the rotating device of the encoder and generates a unique position value or signal based on the absolute or true angular position of the rotating device.

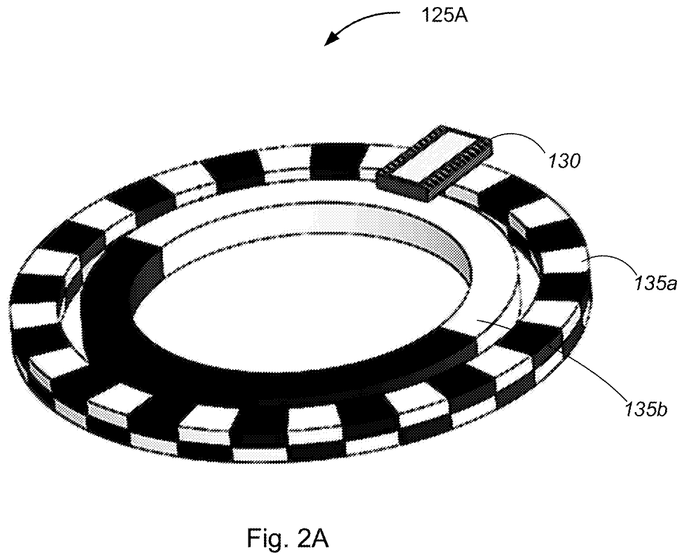

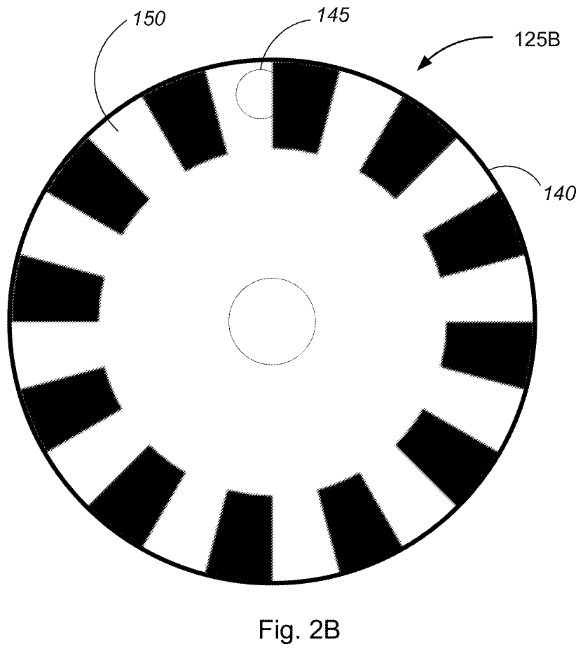

In various instances, the exciter 125 is a rotating device of the encoder 110. In some cases, the exciter 125 is coupled to the rotating body 105. When the rotating body 105 rotates, the exciter 125 also rotates. The exciter 125 can be a different rotating device depending on whether the encoder is a magnetic encoder, an optical encoder, or the like. For example, as indicated above and as shown in FIG. 2A, the exciter 125a can be a magnetized wheel or ring or the like for a magnetic encoder. In the case of FIG. 2A, there are two magnetic wheels 135a and 135b comprising one or more magnets. The term “magnet” may refer to a material or object that produces a magnetic field (e.g., a force field that either pulls or repels certain materials, such as nickel or iron) and can include, without limitation, a permanent magnet, a temporary magnet, an electromagnet, or the like. Each magnet may have one or more pole pairs. A “pole pair” may refer to a pair of north and south poles, which are associated with the direction of the magnetic field.

Alternatively, as indicated above and as shown in FIG. 2B, the exciter 125b can be a code wheel or code disc 140 for an optical encoder. For an optical encoder, the encoder might further include light source 145 (e.g., a light emitting diode, a laser, or the like) and one or more openings 150 shown in FIG. 2B. The one or more openings 150 may be different shapes, sizes, or the like. In some cases, the one or more openings 150 might be one or more transparent pieces of material. The light source 145 might be configured to emit light toward the sensor 130 (not shown in FIG. 2B). As the exciter 125b rotates, the light from the light source 145 can be transmitted through the one or more openings 150 in exciter 125b toward the first sensor 130.

The first sensor 130 is positioned and configured to detect a position of the exciter 125 and identify changes in the angular position of the exciter 125. Based on the position of the exciter 125, the first sensor 130 generates one or more signals indicating the angular position of the exciter 125. In some embodiments, the exciter 125 rotates relative to the first sensor 130 that is stationary.

In the case of a magnetic encoder, the first sensor 130 detects a position of the exciter 125a by detecting a magnetic field associated with the exciter 125a as the exciter 125a rotates. The first sensor 130 can include a Hall effect sensor or other type of magnetosensitive or magnetoresistive sensor, such as an Anisotropic Magnetoresistive (AMR) sensor, a Giant Magnetoresistive (GMR) sensor, and Tunnelling Magnetoresistive (TMR) sensor, or the like. Different magnetic fields may be formed at different positions along the exciter 125a. These different magnetic fields may vary based on the size (e.g., width, length, etc.) of the pole pairs, the number of magnets used, or the like.

In the case of an optical encoder, the first sensor 130 is configured to detect changes in light emitted from the light source 145 through the openings 150 as the exciter 125b rotates. The first sensor 130 might be a photoelectric sensor, a photodetector sensor, or the like. Different patterns of light may be formed at different positions along the exciter 125b depending on the size (e.g., width, length, etc.) of the one or more openings 150, depending on an amount of light emitted through the one or more openings, or the like.

In the case of the magnetic encoder where the first sensor 130 detects a magnetic field of the exciter 125a or the optical encoder where the first sensor 130 detects a light emitted from a light source through the exciter 125b, the first sensor 130 generates a signal or one or more signals based on the detected magnetic field or the detected light. Differences in the magnetic field of the exciter 125a or light emitted through the exciter 125b can be represented by different parts of the signal. The signal might include electrical signals configured in sinusoidal waveforms. In other words, the signal that is generated can include at least a sine signal and a cosine signal.

The first sensor 130 can then send those signals to the controller 120. Based on the signals generated by the first sensor 130, the controller 120 can determine the angular position of the exciter 125. In a non-limiting example, in order to determine a first position of the exciter 125, the first sensor 130 might detect a first magnetic field or a first pattern of emitted light and generate a signal based on the detected first magnetic signal or first pattern of emitted light. Next, the controller 120 might receive that signal and determine a position associated with the exciter 125 based on the signal generated from the detection of the first magnetic field or the first pattern. Based on the position of the exciter 125, the controller 120 can further determine the position of the rotating body 105 of the motor.

The temperature sensor 155 of the encoder can detect a temperature of an environment (e.g., factory, shop, warehouse, outside, etc.) in which the encoder 110 is operating. The temperature sensor 155 may be at least one of a thermocouple, resistance temperature detector, thermistor, or other temperature sensor capable of determining a temperature of an environment. In some cases, the temperature sensor is coupled to an exciter 125 of the encoder 110 or another part of the encoder 110.

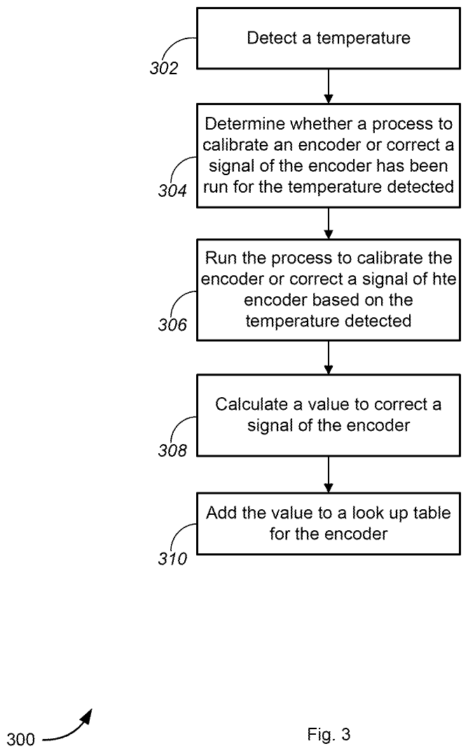

Turning to FIG. 3, FIG. 3 is a flow diagram illustrating a process or method to calibrate an encoder or correct a signal of the encoder based on temperature, in accordance with various embodiments. This diagram merely provides an example, which should not unduly limit the scope of the claims. In some embodiments, the encoder 110 shown in FIG. 1 is capable of performing the automatic calibration or automatic correction method 300 described in FIG. 3. However, the method is not limited to only being performed with the encoder of FIG. 1 and can be performed by other encoders or types of encoders. In some cases, a processor or controller (e.g., processor or controller 130) of the encoder is configured to execute the method 300. In some cases, multiple controllers are configured to execute different blocks or steps of the method 300. Alternatively, a single controller is configured to execute the blocks or steps of the process 300.

The method 300 can begin at block 302 by detecting a first temperature of an environment using a temperature sensor of the encoder. The detection of the first temperature of the environment can be performed using a temperature sensor (e.g., temperature sensor 155) of the encoder. The temperature sensor can continuously detect the temperature of the environment, detect the temperature of the environment upon start-up of the encoder or motor (e.g., motor 115), or the like. In some cases, the temperature sensor can run when the encoder is turned off and, upon detection of a new temperature, cause the encoder to turn on and run a new process to calibrate the encoder or correct a signal of the encoder.

Based on the first temperature detected, the method can continue to block 304 and determine whether a first process to calibrate the encoder or correct a signal of the encoder has been run for the first temperature detected. In some cases, the first temperature may be part of a predetermined range of temperatures for which a process to calibrate the encoder or correct a signal of the encoder has not been run. In some cases, the predetermined range might be every 1 degree, every 5 degrees, every 10 degrees, or the like. In a non-limiting example, if the process to calibrate the encoder or correct the signal of the encoder has not been run for a predetermined range of temperatures between 40 degrees Celsius and 45 degrees Celsius and the temperature sensor detects a temperature of 42 degrees Celsius, then the first process to calibrate the encoder or correct a signal of the encoder can be run for 42 degrees Celsius.

Next, based on a determination that the first process to calibrate the encoder or correct a signal of the encoder has not been run for the first temperature detected, the method 300 might continue on to block 306 by running the process to calibrate the encoder or correct the signal of the encoder based on the first temperature detected. The process to calibrate the encoder or correct a signal of the encoder can be similar to the process described in application Ser. No. 18/466,801, “Automatic Calibration of Encoders” or application Ser. No. 18/466,811, “Automatic Stabilization of Encoders.”

In some cases, the first process to calibrate the encoder or correct a signal of the encoder might only be performed when the encoder is not in use (e.g., when a user of the encoder is not using the encoder to track a position of a rotating body, etc.). In a non-limiting example, the current use of the encoder can be detected by observing the communication to the superordinate control (e.g., a master controller or the like). If the encoder is in use (e.g., being used to perform a specific task or for a specific purpose, or the like), then the encoder might pause or stop the process to calibrate the encoder or correct the signal of the encoder until the encoder is no longer in use. Alternatively, in other cases, the process to correct the signal of the encoder can be run in the background in real-time while the encoder is operating in real time (similar to the process described in (application Ser. No. 18/466,811, “Automatic Stabilization of Encoders”). Once the encoder determines that it is no longer being used, the temperature sensor might redetect the temperature of the environment and, based on a determination that the encoder has not been calibrated or the signal has not been corrected for the detected temperature, the encoder can restart the process to calibrate the encoder or correct the signal of the encoder.

In various instances, the calibration of the encoder might only be run based on a detection of an about constant temperature of the environment for a predetermined amount of time (e.g., 1 minute, 5 minutes, or the like). In addition, in some cases, the calibration of the encoder might only be performed based on a detection that the exciter is rotating at about a constant speed for a predetermined amount of time (e.g., 1 minute, 5 minutes, or the like).

In some embodiments, based on the first process to calibrate the encoder or correct the signal of the encoder and the first temperature, the method 300 further includes at block 308 calculating a first value to correct the signal received from the first sensor (e.g., first sensor 130) detecting a position of the exciter (e.g., exciter 125) of the encoder. In some cases, the first value includes an offset value to correct an offset of the signal, a gain value to correct the gain of the signal, and a phase value to correct a phase of the signal. In some cases, when a rotation of the encoder is divided into one or more segments (as described in application Ser. No. 18/466,801, “Automatic Calibration of Encoders”), the first value can be calculated for each segment. These calculation steps of the first value are described in application Ser. No. 18/466,801, “Automatic Calibration of Encoders” or application Ser. No. 18/466,811, “Automatic Stabilization of Encoders.”

Once the first value to correct the signal received from the first sensor is calculated, this first value is added at block 310 to a look up table (“LUT”) for the encoder. The look up table for the encoder stores one or more values to correct a signal of the encoder. The first value added to the look up table is associated with the first temperature detected by the temperature sensor. In a non-limiting example, if the temperature detected was 42 degrees Celsius, then the first value is associated with 42 degrees Celsius and stored in the look up table in association with 42 degrees Celsius. The look up table can be stored in a memory of the encoder or on a memory external to the encoder.

The values stored in the look up table can also be used to calculate (e.g., with a linear or polynomial based interpolation) the compensation or correction values for the temperatures not yet calibrated. It may also be possible to preload the look up table (e.g., at the factory) with standard values taken from reference sensors or reference encoders or with the data from a statistical analysis of encoders calibrated at different temperatures. In this case, the calibration process of block 304 can be started when the first temperature was not yet calibrated or corrected for the particular encoder and the new calculated values for the compensation or correction can be used to overwrite the values in the look up table.

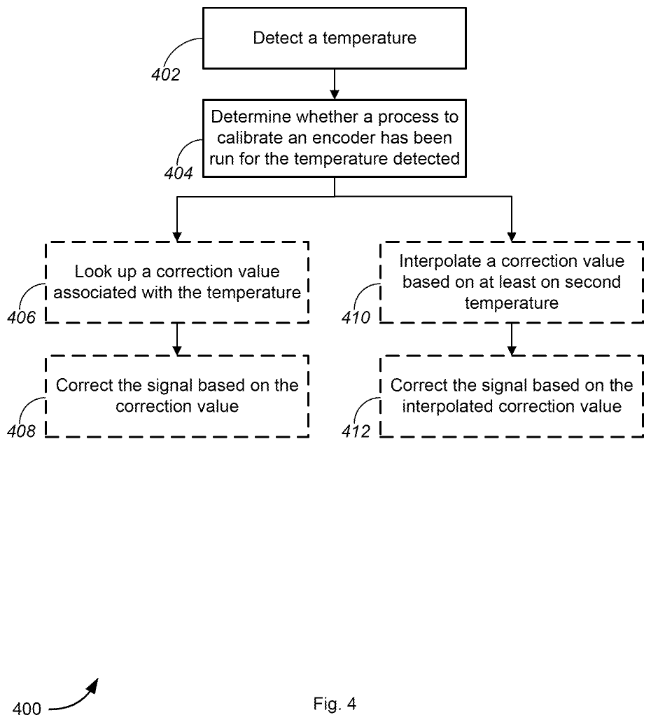

Turning to FIG. 4, FIG. is a flow diagram illustrating a process or to correct a signal of the encoder based on a detected temperature, in accordance with various embodiments.

The method 400 can begin at block 402 by detecting a first temperature of an environment using a temperature sensor of the encoder. The detection of the first temperature of the environment can be performed using a temperature sensor (e.g., temperature sensor 155) of the encoder. The temperature sensor can continuously detect the temperature of the environment, detect the temperature of the environment upon start-up of the encoder or motor (e.g., motor 115), or the like.

Based on the first temperature detected, the method can continue to block 404 and determine whether a first process to calibrate the encoder has been run for the first temperature detected. In some cases, the first temperature may be part of a predetermined range of temperatures. In some cases, the predetermined range might be every 1 degree, every 5 degrees, every 10 degrees, or the like.

Next, based on a determination that the first process to calibrate the encoder or correct a signal of the encoder has been run for the first temperature detected, the method 400 might continue on to optional block 406. Alternatively, based on a determination that the first process to calibrate the encoder or correct a signal of the encoder has been run for at least one temperature within a predetermined range of temperatures, the method 400 might continue on to optional block 410.

At optional block 406, the method can look up (e.g., in a look up table) the correction value or first value associated with the detected temperature. In a non-limiting example, when the encoder is in use and the temperature sensor detects 42 degrees Celsius, then the encoder will look up the first value associated with 42 degrees Celsius to correct the signal from the first sensor of the encoder. The look up table for the encoder can contain one or more values to correct a signal of the first sensor based on different temperatures. Thus, when the temperature sensor detects a particular temperature, the encoder can choose a value stored in the look up table to correct the signal based on the detected temperature.

In some cases, when the first temperature is part of a predetermined range of temperatures, then one or more other values to correct the signal for temperatures of the predetermined range can be calculated using the first temperature. In a non-limiting example, if the predetermined range of temperatures is between 40 degrees Celsius and 45 degrees Celsius and the process to calibrate the encoder was run for a temperature of 42 degrees Celsius, then one or more other values for the other temperatures (e.g., 40° C., 41° C., 43° C., 44° C., and 45° C.) can be determined using at least the value for 42° C. These correction values for the other temperatures may be determined or interpolated using at least one of a linear formula (e.g., y=mx+b) or a polynomial formula (f(x)=aₙxⁿ÷aₙ₋₁xⁿ⁻¹+ . . . ÷a₂x²+a₁x¹+a₀) based on at least the first value associated with 42° C. Alternatively, in other cases, when the first temperature is part of a predetermined range of temperatures, then the first value can be used to correct the signal for the other temperatures. In a non-limiting example, the first value to correct the signal for 42° C. can be used to correct the signal when the temperature sensor detects 40° C., 41° C., 43° C., 44° C., and 45° C.

After determining the correction value for the detected temperature, the method 400 can continue to optional block 408 and correct the signal based on the correction value in the look up table. In order to correct the signal, the controller can generate a corrected signal based on the correction value and the signal generated by the first sensor. In this way, a process to correct the signal of the encoder can be run upon detection of a temperature having an associated correction value in a look up table.

In various instances, the method 400 might continue on to optional block 410 based on a determination that the first process to calibrate the encoder or correct a signal of the encoder has not been run for the first temperature detected. However, the encoder might not be able to run the second process to calibrate the encoder or correct a signal of the encoder because the encoder is currently being used or the conditions (e.g., constant temperature for a predetermined amount of time, constant speed for a predetermined amount of time, etc.) for a calibration are not met. In this scenario, the encoder or a controller of the encoder can calculate a correction value to correct the signal associated with the detected temperature. The correction value can be calculated using a value associated with a temperature for which a corresponding process to calibrate the encoder or correct the signal has been run. In some cases, the temperature is a temperature that is nearest or closest to the detected temperature without any temperatures in between.

Based on the non-limiting example above, if the temperature is 45° C. and the first process to calibrate the encoder has been run for 42° C., but not 43° C., 44° C., 46° C., 47° C., or 48° C., then the encoder or controller can use 42° C. to calculate the value to correct the signal for 45° C. This correction value for the detected temperature may be determined or interpolated using at least one of a linear formula or a polynomial formula based on the temperature for which a corresponding process to calibrate the encoder or correct the signal has been run.

After calculating the correction value for the detected temperature, the method 400 can continue to optional block 412 and correct the signal based on the calculated correction value. In order to correct the signal, the controller can generate a corrected signal based on the calculated correction value and the signal generated by the first sensor. In this way, a process to correct the signal of the encoder can be run upon detection of a new temperature or a new temperature within a predetermined range of temperatures.

The techniques and processes described above with respect to various embodiments may be used to calibrate the encoder 110, and/or components thereof based on a temperature detected by a temperature sensor 155, as described herein.

While some features and aspects have been described with respect to the embodiments, one skilled in the art will recognize that numerous modifications are possible. For example, the methods and processes described herein may be implemented using hardware components, custom integrated circuits (ICs), programmable logic, and/or any combination thereof. Further, while various methods and processes described herein may be described with respect to particular structural and/or functional components for ease of description, methods provided by various embodiments are not limited to any particular structural and/or functional architecture but instead can be implemented in any suitable hardware configuration. Similarly, while some functionality is ascribed to one or more system components, unless the context dictates otherwise, this functionality can be distributed among various other system components in accordance with the several embodiments.

Referring generally again to FIGS. 1, 3, and 4, for the purposes of the present disclosure, the term “controller,” “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). Furthermore, the memory may include any storage medium known in the art suitable for storing program instructions executable by the associated processor. For example, the memory medium may include a non-transitory memory medium. By way of another example, the memory medium may include, but is not limited to, a read-only memory (ROM), a random-access memory (RAM), a magnetic or optical memory device (e.g., disk), a solid-state drive and the like. It is further noted that memory medium may be housed in a common controller housing with the processor. In embodiments, the memory medium may be located remotely with respect to the physical location of the processor.

In the present disclosure, the methods, operations, and/or functionality disclosed may be implemented as a step switching hardware system and/or as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

What is claimed is:

1. An encoder comprising:
an exciter;
a first sensor configured to detect a first temperature of an environment;
a second sensor configured to detect a position associated with the exciter and generate a signal based on the position associated with the exciter; and
a controller configured to:
detect the first temperature of the environment using the first sensor;
determine a first process to correct the signal has not been run for the first temperature;
based on a determination that the first process has not been run for the first temperature, running the first process to correct the signal based on the first temperature; and
based on the first process and the first temperature, calculate a first value to correct the signal received from the second sensor.

2. The encoder of claim 1, wherein the first value to correct the signal of the encoder comprises at least one of a first correction value to correct an offset of the signal, a second correction value to correct a gain of the signal, or a third correction value to correct a phase of the signal.

3. The encoder of claim 1, wherein the first process to correct the signal of the encoder occurs as the encoder is operating.

4. The encoder of claim 1, the controller further configured to:
after calculating the first value, add the first value to a look-up table for the encoder and associate the first value with the first temperature detected.

5. The encoder of claim 4, the controller further configured to:
use the look-up table to correct the signal received from the first sensor based on a detection of a second temperature of the environment, wherein using the look-up table comprises:
looking up the second temperature of the environment in the look up table to determine a second value to correct the signal received from the second sensor; and
using the second value from the look up table to correct the signal based on the second temperature.

6. The encoder of claim 5, wherein, in response to a first determination that a second value to correct the signal is not stored in the look-up table for the second temperature and in response to a second determination that a second process to correct the signal cannot be run for the second temperature, the controller is further configured to calculate the second value associated with the second temperature, wherein the second value is calculated using a third value to correct the signal associated with a third temperature for which a corresponding process to correct the signal of the encoder has been run.

7. The encoder of claim 6, wherein the second value is calculated using a linear formula using the third value associated with the third temperature.

8. The encoder of claim 1, wherein determining whether the first process has been run for the first temperature detected, further comprises determining whether the first temperature detected is within a predetermined range of temperatures that have not been corrected and, based on a determination that the first process has not been run for the predetermined range of temperatures, running the first process based on the first temperature detected.

9. The encoder of claim 8, the controller further configured to:
after calculating the first value, add the first value to a look-up table for the encoder and associate the first value with the first temperature detected; and
determine an additional value for an other temperature within the predetermined range based on the first value associated with the first temperature detected.

10. The encoder of claim 9, wherein the additional value is determined using at least one of a linear formula or a polynomial formula.

11. The encoder of claim 9, wherein the look-up table is stored on a memory of the encoder.

12. The encoder of claim 1, the controller further configured to:
determine whether the encoder is being used; and
based on a determination that the encoder is being used, delay or stop the first process to correct the signal of the encoder.

13. A method for correcting a signal of an encoder, the method comprising:
detecting a first temperature of an environment using a first sensor of the encoder;
determining a first process to correct the signal has not been run for the first temperature detected;
based on a determination that the first process to correct the signal has not been run for the first temperature detected, running the first process based on the first temperature detected; and
based on the first process, calculating a first value to correct a signal received from a second sensor of the encoder.

14. The method of claim 13, wherein the first value to correct the signal of the encoder comprises at least one of a first correction value to correct an offset of the signal, a second correction value to correct a gain of the signal, or a third correction value to correct a phase of the signal.

15. The method of claim 13, the method further comprising:
after calculating the first value, adding the first value to a look-up table for the encoder and associating the first value with the first temperature detected; and
using the look-up table to correct the signal received from the second sensor based on a detection of a second temperature of the environment.

16. The method of claim 15, wherein, in response to a first determination that a second value is not stored in the look-up table for the second temperature and in response to a second determination that a second process to correct the signal cannot be run for the second temperature, calculating a second value associated with the second temperature, wherein the second value is calculated using a third value associated with a third temperature for which a corresponding process to correct the signal of the encoder has been run.

17. The method of claim 16, wherein the second value is calculated using a linear formula using the third value associated with the third temperature.

18. The method of claim 13, wherein determining whether the first process has been run for the first temperature detected, further comprises determining whether the first temperature detected is within a predetermined range of temperatures that have not been corrected and, based on a determination that the first process has not been run for the predetermined range of temperatures, running the first process based on the first temperature detected.

19. The method of claim 18, the method further comprising:
after calculating the first value, adding the first value to a look-up table for the encoder and associating the first value with the first temperature detected; and
determining an additional value to correct the signal for an other temperature within the predetermined range based on the first value associated with the first temperature detected.

20. An encoder comprising:
an exciter;
a first sensor configured to detect a temperature of an environment;
a second sensor configured to detect a position associated with the exciter and generate a signal based on the position associated with the exciter; and
a processor configured to:
detect the temperature of the environment using the first sensor;
determine the signal of the encoder has not been corrected for the temperature detected; and
based on a determination that signal has not been corrected for the temperature detected, correct the signal for the temperature detected.
